(19) United States
(12) Patent Application Publication
(10) Pub. No.: US 2008/0143642 A1
(43) Pub. Date: Jun. 19, 2008

(54) PLASMA DISPLAY DEVICE AND DRIVING APPARATUS THEREOF

(76) Inventor: Jin-Boo Son, Yongin-si (KR)

Correspondence Address: CHRISTIE, PARKER & HALE, LLP, PO BOX 7068, PASADENA, CA, 91109-7068, US

(21) Appl. No.: 11/940,240

(22) Filed: Nov. 14, 2007

(30) Foreign Application Priority Data
Dec. 18, 2006 (KR) 10-2006-0129446

(51) Int. Cl. G09G 3/28

(52) U.S. Cl. 345/60

(57) ABSTRACT

A plasma display device and a driving apparatus thereof includes a main switch in order to prevent current from flowing to a power supply that supplies a higher voltage than a negative voltage while the negative voltage is applied to a scan electrode. The main switch is provided only in a current path formed for recovering an energy and applying a ground voltage during the sustain period. Thus, the current that passes through the main switch is reduced and the amount of generated heat is decreased. As a result, the reliability of the main switch can be improved. Further, because the main switch is not provided in a current path formed when the sustain voltage is applied during the sustain period or when the reset rising waveform is applied during the reset period, a distortion of the driving waveform can be prevented.

### CROSS-REFERENCE TO RELATED APPLICATION

This application claims priority to and the benefit of Korean Patent Application No. 10-2006-0129446, filed in the Korean Intellectual Property Office on Dec. 18, 2006, the entire content of which is incorporated herein by reference.

### BACKGROUND OF THE INVENTION

1. Field of the Invention

The present invention relates to a plasma display device and a driving apparatus thereof.

2. Description of the Related Art

Plasma display devices are flat panel displays that display characters or images using plasma generated by gas discharge. A display panel of a plasma display device includes hundreds of thousands to millions of discharge cells (hereinafter, referred to as “cells”) or more, which are arranged in a matrix, according to the size of the display panel.

The plasma display device divides one frame into a plurality of subfields each having a weight value to drive it. In this case, the luminance of the cells is determined by the total weight values of subfields in which the corresponding cells emit light, among the plurality of subfields.

Further, each subfield consists of a reset period, an address period and a sustain period. The reset period is a period when the state of the discharge cell returns to an initial state, and the address period is a period when an address operation is performed so as to select light emitting cells among the discharge cells. The sustain period is a period when the cell that is set as a light emitting cell during the address period sustain-discharges during a period corresponding to the weight value of the subfield to display images.

Generally, display panels of plasma display devices are configured such that a plurality of scan electrodes and a plurality of sustain electrodes are arranged in the same direction, a plurality of address electrodes are arranged in the crossing direction of the scan electrodes and the sustain electrodes, and cells are formed at intersections of the scan electrodes, the sustain electrodes and the address electrodes. The plasma display devices include a scan electrode driver, a sustain electrode driver and an address electrode driver that are connected to the scan electrodes, the sustain electrodes and the address electrodes, respectively.

The scan electrode driver applies a voltage waveform to the scan electrodes that gradually increases to the maximum reset voltage during the reset period, and then applies a waveform that gradually decreases to the minimum reset voltage. Further, the scan electrode driver sequentially applies a negative scan voltage to the plurality of scan electrodes during the address period, and applies a sustain discharge pulse of a sustain voltage and a reference voltage to the scan electrodes during the sustain period. The sustain discharge pulse of the sustain voltage and the reference is reverse to the sustain discharge pulse for the sustain electrodes.

FIG. 1 illustrates a scan electrode driver for a driving circuit of a known plasma display device.

As shown in FIG. 1, the scan electrode driver includes a selective circuit 10, a diode DscH, a capacitor CscH, transistors YscL, Ynp, Yrr, Yfr, Ys, Yg and an energy recovery unit 20.

The transistor Ys has a drain that is connected to a power supply Vs supplying a sustain voltage. When the transistor Ys is turned on during the sustain period, through a current path formed by the power supply Vs, the transistors Ys, Ynp, a transistor Scl of the selective circuit 1, and the scan electrode, the sustain voltage is applied to the scan electrode.

A source of the transistor Yg is connected to a GND power supply that supplies a reference voltage. When the transistor Yg is turned on during the sustain period, through a current path formed by the scan electrode, the transistor Scl of the selective circuit 1, the transistors Ynp, Yg and the GND power supply, the reference voltage is applied to the scan electrode.

Generally, the maximum reset voltage is determined by the sum of the rising start voltage and the rising voltage. The rising start voltage may be set by a voltage difference between the scan voltage of the capacitor CscH and a non-scan voltage.

A drain of the transistor Yrr is connected to a power supply Vset that supplies a rising voltage, and when the transistor Yrr is turned on during the reset period, through a current path formed by the power supply Vset, the transistors Yrr, Ynp, the capacitor CscH, a transistor Sch of the selective circuit 1 and the scan electrode, the voltage of the scan electrode is increased. In this case, the transistor Yrr is alternatively turned on and turned-off to gradually increase the voltage of the scan electrode from the rising start voltage to the maximum reset voltage.

Even though not shown in FIG. 1 in detail, the energy recovery unit 2 includes an energy recovery inductor and an energy recovery capacitor that charges a voltage ranged between a voltage of 0 and Vs, and generates an LC resonance current by the energy recovery inductor and the energy recovery capacitor to increase or to decrease the voltage of the scan electrode. In this case, the LC resonance current generated while the energy recovery unit 2 operates passes through the transistor Ynp.

As described above, in the scan electrode driving unit, the transistor Ynp is included in the current path of a current for applying the sustain voltage, the reference voltage, and a gradually increasing voltage waveform and the LC resonance current by the energy recovery unit 2.

Accordingly, because the amount of current that passes through the transistor Ynp is increased, the high heat may be generated from the transistor Ynp, which damages or breaks the elements. Further, because the transistor Ynp is included in the current path that applies the sustain voltage or the gradually increasing voltage waveform to the scan electrode, the voltage waveform may be distorted.

### SUMMARY OF THE INVENTION

An exemplary embodiment of the present invention provides a plasma display device including a plasma display panel (PDP) including a plurality of electrodes and a driver that applies a driving voltage to the plurality of electrodes. The driver may include a first transistor having a first terminal connected to a first power supply that supplies a first voltage applied to the plurality of electrodes during a sustain period, a second transistor having a first terminal connected to a second power supply that supplies a second voltage applied to the plurality of electrodes during the sustain voltage, the second voltage being lower than the first voltage, a third transistor having a first terminal connected to a third power supply that supplies a third voltage, the third voltage being lower than the second voltage, and a fourth transistor that has a first terminal connected to a second terminal of the first transistor and a second terminal of the third transistor, and a second terminal connected to a second terminal of the second transistor. The fourth transistor is turned off while a voltage lower than the second voltage is applied to the plurality of electrodes.

Further, the driver in an exemplary embodiment may include a fifth transistor having a first terminal connected to a fourth power supply that supplies a fourth voltage, and a second terminal connected to a first terminal of the fourth transistor. The fifth transistor operates such that the voltage of the first terminal of the fourth transistor is gradually increased to the fourth voltage during a first period of the reset period. In this case, the level of the fourth voltage may be the same as the first voltage. When the fifth transistor is turned on, a current path may be formed by the fourth power supply, the fifth transistor, and the plurality of electrodes.

The driver in an exemplary embodiment may further include a Zener diode having a cathode connected to the first terminal of the fourth transistor and a sixth transistor having a first terminal connected to an anode of the Zener diode, and a second terminal connected to the third power supply. The sixth transistor operates such that a voltage of the first terminal of the fourth transistor is gradually decreased to a fifth voltage lower than the fourth voltage during a second period of the reset period. In this case, the fifth voltage may be higher than the third voltage by a breakdown voltage of the Zener diode, and when the sixth transistor is turned on, a current path may be formed by the third power supply, the sixth transistor, the Zener diode and the plurality of electrodes.

When the first transistor is turned on, a current path may be formed by the first power supply, the first transistor, and the plurality of electrodes, and when the second transistor and the fourth transistor are turned on, a current path may be formed by the second power supply, the second transistor, the fourth transistor, and the plurality of electrode.

The second transistor may include a body diode having a cathode connected to a drain of the second transistor and an anode connected to a source of the second transistor.

Another exemplary embodiment of the present invention provides a driving apparatus for a plasma display device including a plurality of electrodes including a first transistor having a first terminal connected to a first power supply that supplies a first voltage applied to the plurality of electrodes during a sustain period, a second transistor having a first terminal connected to a second power supply that supplies a second voltage, and operating such that a voltage of a second terminal of the second transistor is gradually increased to the second voltage during a reset period, a third transistor having a first terminal connected to a third power supply that supplies a third voltage applied to the plurality of electrodes during the sustain voltage, the third voltage being lower than the first voltage, and a fourth transistor that has a first terminal connected to a second terminal of the first transistor and a second terminal of the second transistor, and a second terminal connected to a second terminal of the third transistor. The fourth transistor is turned off while a voltage lower than the third voltage is applied to the plurality of electrodes.

In this case, the fourth transistor may be turned off while the first transistor and the second transistor are operated.

When the third transistor and the fourth transistor are turned on, a current path may be formed by the third power supply, the third transistor, the fourth transistor and the plurality of electrodes to apply the second voltage to the plurality of electrodes.

Still another exemplary embodiment of the present invention provides a driving apparatus for a plasma display device further including a fifth transistor having a first terminal connected to a fourth power supply that supplies a fourth voltage, and a second terminal connected to a first terminal of the fourth transistor, the fourth voltage being lower than the third voltage, a Zener diode having a cathode connected to the first terminal of the fourth transistor; and a sixth transistor having a first terminal connected to an anode of the Zener diode, and a second terminal connected to the fourth power supply. The sixth transistor operates such that the voltage of the first terminal of the fourth transistor is gradually decreased to a fifth voltage higher than the fourth voltage during a second period of the reset period. The fifth voltage corresponds to a sum of the fourth voltage and the breakdown voltage of the Zener diode.

The third transistor may include a body diode having a cathode connected to a drain of the third transistor and an anode connected to a source of the third transistor and the level of the second voltage may be the same as the first voltage.

### BRIEF DESCRIPTION OF THE DRAWINGS

FIG. 1 illustrates a scan electrode driver for a driving circuit of a known plasma display device.

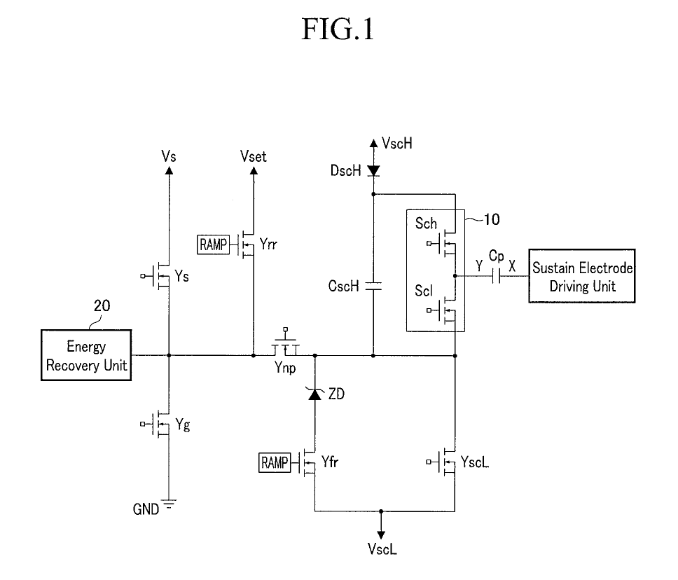

FIG. 2 illustrates a simplified block diagram of a plasma display device according to an exemplary embodiment of the present invention.

FIG. 3 is a drawing illustrating a driving waveform of the plasma display device according to an exemplary embodiment of the present invention.

FIG. 4 illustrates a scan electrode driver according to an exemplary embodiment of the present invention.

FIG. 5 illustrates a timing chart of transistors in the scan electrode driver according to an exemplary embodiment of the present invention shown in FIG. 4 during a reset period.

FIG. 6 illustrates a driving operation of the scan electrode driver according to an exemplary embodiment of the present invention shown in FIG. 4 during a rising period of the reset period.

FIG. 7 illustrates a driving operation of the scan electrode driver according to an exemplary embodiment of the present invention shown in FIG. 4 during a falling period of the reset period.

FIG. 8 illustrates a driving operation of the scan electrode driver according to an exemplary embodiment of the present invention shown in FIG. 4 during a sustain period.

### DETAILED DESCRIPTION

Throughout this specification and the claims that follow, when it is described that a first element is “coupled” to a second element, the first element may be “directly coupled” to the second element or “electrically coupled” to the second element through a third element.

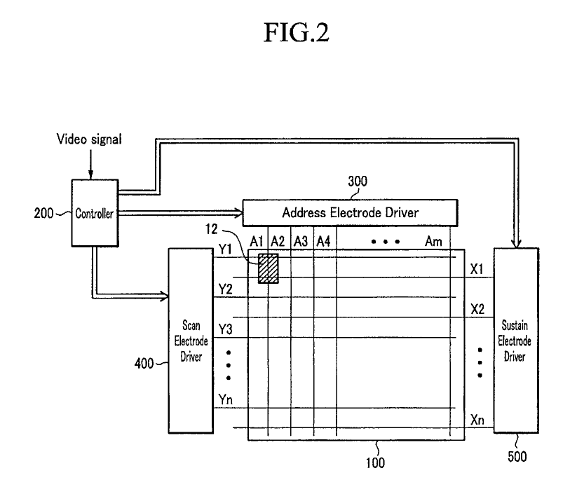

FIG. 2 illustrates a conceptual view of a plasma display device according to an exemplary embodiment of the present invention.

As shown in FIG. 2, the plasma display device according to an exemplary embodiment of the present invention includes a plasma display panel (PDP) 100, a controller 200, an address electrode driver 300, a scan electrode driver 400 and a sustain electrode driver 500. The PDP 100 includes a plurality of address electrodes A1 to Am (hereinafter, referred to as A electrodes) extending in a column direction, a plurality of sustain electrodes X1 to Xn (hereinafter, referred to as X electrodes) and a plurality of scan electrodes Y1 to Yn (hereinafter, referred to as Y electrodes) extending in a row direction. The plurality of Y electrodes Y1 to Yn and X electrodes X1 to Xn are arranged in pairs. Discharge cells 12 are formed at intersections of adjacent Y electrodes Y1 to Yn and X electrodes X1 to Xn and the A electrodes A1 to Am.

The controller 200 receives an external video signal to output an address electrode driving control signal, a sustain electrode driving control signal and a scan electrode driving control signal. Further, the controller 200 divides one frame into a plurality of subfields each having a weight value.

The address electrode driver 300 receives the address electrode driving control signal from the controller 200 to apply a signal for selecting a desired discharge cell to the A electrodes A1 to Am. The scan electrode driver 400 receives the scan electrode driving control signal from the controller 200 to apply a driving voltage to the Y electrodes Y1 to Yn, and the sustain electrode driver 500 receives the sustain electrode driving control signal from the controller 200 to apply the driving voltage to the X electrodes X1 to Xn.

Next, a driving waveform of the plasma display device according to an exemplary embodiment of the present invention will be described. Hereinafter, driving waveforms that are applied to a Y electrode, an X electrode and an A electrode forming a single cell will be described for convenience.

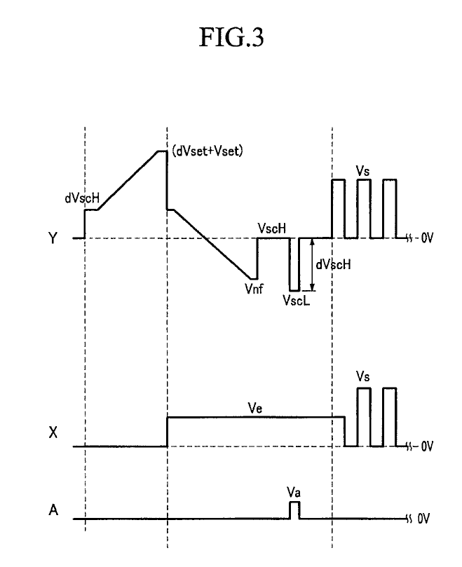

FIG. 3 is a drawing illustrating a driving waveform of the plasma display device according to an exemplary embodiment of the present invention.

As shown in FIG. 3, during a rising period of the reset period, while a reference voltage (in FIG. 3, the reference voltage is 0 V, and hereinafter, referred to as 0 V-voltage) is applied to the A electrode and the X electrode, a voltage waveform (hereinafter, referred to as reset rising waveform) that gradually increases from a predetermined voltage (that is indicated by dVscH in FIG. 3, and referred to as rising start voltage) to the maximum reset voltage (that is indicated by dVscH+Vset in FIG. 3) is applied to the Y electrode. The dVscH voltage that is used as the rising start voltage is a voltage difference between the non-scan voltage and the scan voltage.

As described above, while the reset rising waveform is applied to the Y electrode, weak discharge occurs between the Y electrode and the X electrode and between the Y electrode and the A electrode. Therefore, due to the weak discharge generated by the reset rising waveform that is applied to the Y electrode, a negative wall charge is formed in the Y electrode, and a positive wall charge is formed in the X and A electrodes.

During a falling period of the reset period, while the 0 V-voltage and a bias voltage (that is indicated by Ve in FIG. 3 and referred to as Ve voltage) are applied to the A electrode and the X electrode, respectively, a voltage waveform (referred to as reset falling waveform) that gradually decreases from a predetermined voltage (indicated by dVscH in FIG. 3 and referred to as falling start voltage) and the minimum reset voltage (indicated by Vnf in FIG. 3) is applied to the Y electrode. As such, while the reset falling waveform is applied to the Y electrode, weak discharge occurs between the Y electrode and the X electrode and between the Y electrode and the A electrode to erase the negative wall charge formed in the Y electrode and the positive wall charge formed in the A electrode.

Generally, the voltage difference (Vnf−Ve) between the minimum reset voltage and the bias voltage is set near a discharge firing voltage Vfxy between the Y electrode and the X electrode. In this case, the discharge firing voltage Vfxy between the Y electrode and the X electrode refers to a voltage when starting discharging between the Y electrode and the X electrode in a state that the wall voltage between the Y electrode and the X electrode is assumed to be 0 V. Accordingly, when the voltage difference (Vnf−Ve) between the minimum reset voltage and the bias voltage is set near a discharge firing voltage Vfxy between the Y electrode and the X electrode, the wall voltage between the Y electrode and the X electrode becomes almost 0 V. Therefore, the cell that is not address-discharged during the address period can be prevented from being misfired during the sustain period.

Even though not shown separately, after the reset starting voltage is applied, and then the 0 V-voltage is applied, if the reset falling waveform is configured as a waveform that gradually decreases from the 0 V-voltage to the minimum reset voltage, the time required for initializing the state of the wall charge can be reduced, and the contrast can be improved. Further, the strong discharge generated due to the steep slope of the reset falling waveform can be prevented.

Furthermore, even though the starting voltage of the reset rising waveform and the starting voltage of the reset falling waveform are represented as dVscH voltage in FIG. 3, the starting voltage of the reset rising waveform and the starting voltage of the reset falling waveform according to an exemplary embodiment of the present invention may be set to a voltage lower than the discharge firing voltage Vfxy between the Y electrode and the X electrode, such as the sustain voltage.

During the address period, in order to select a cell to be turned on, scan voltages (indicated by VscL in FIG. 3, and referred to as VscL voltage) that are lower than the 0 V-voltage are sequentially applied to the plurality of Y electrodes while the Ve voltage is applied to the X electrode. In this case, an address voltage (indicated by Va in FIG. 3 and referred to as Va voltage) is applied to the A electrode that passes through a discharge cell to be selected among the plurality of discharge cells to which VscL voltage is applied by the Y electrode. Accordingly, address discharge occurs between the A electrode to which the Va voltage is applied and the Y electrode to which the VscL voltage is applied, and between the Y electrode to which the VscL voltage is applied and the X electrode to which the Ve voltage is applied, to form the positive wall charge and the negative wall charge in the Y electrode and the A electrode and X electrode, respectively. The VscL voltage may be set to a voltage level that is equal to or lower than the Vnf voltage. Further, a non-scan voltage (indicated by VscH in FIG. 3 and referred to as VscH voltage) that is higher than the VscL voltage is applied to at least one of the Y electrodes to which the VscL voltage is not applied, and the 0 V-voltage is applied to the A electrode of the non selected discharge cell.

During the sustain period, a sustain voltage (indicated by Vs in FIG. 3 and referred to as Vs voltage hereinafter) and the 0 V-voltage are applied to the Y electrode and the X electrode to sustain the sustain discharge between the Y electrode and the X electrode. In this case, the polarity of the Vs voltage is reverse to the 0 V voltage. That is, the process of simultaneously applying the Vs voltage and the 0 V-voltage to the Y electrode and the X electrode, respectively, and the process of simultaneously applying the 0 V-voltage and the Vs voltage to the Y electrode and the X electrode, respectively, are repeatedly a number of times corresponding to the weight value of the subfield.

Even though, in FIG. 3, the reset rising waveform or reset falling waveform that is applied to the Y electrode during the reset period is shown as a ramp waveform for convenience, in an exemplary embodiment of the present invention, the reset rising waveform or the reset falling waveform may be applied to any waveform that gradually rises or falls, such as an RC waveform or a waveform that floats while gradually rising (or falling).

Further, in FIG. 3, even though the maximum reset voltage is indicated by (dVscH+Vset) voltage, the Vset voltage may be substituted by the Vs voltage. That is, as the Vset voltage is set to the same level as the Vs voltage, the power supply for supplying the Vset voltage may be omitted. Because the method in which the Vset voltage is omitted and the maximum reset voltage is produced by using the Vs voltage supplied from the Vs power supply is well known to a person of an ordinary skill in the art, the detailed description thereof will be omitted.

Next, in the scan electrode driver 400 that generates the driving waveform of the Y electrode shown in FIG. 3, an exemplary embodiment of the present invention that prevents damage or breakage of the elements will be described.

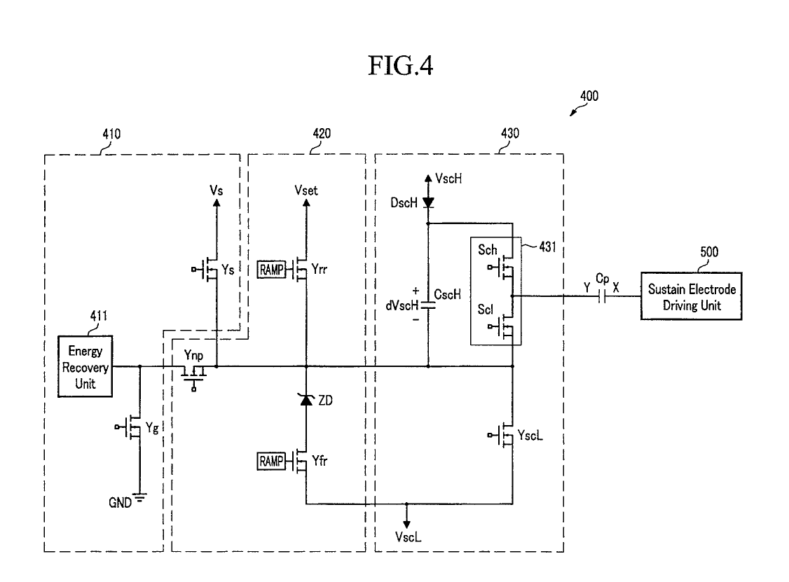

FIG. 4 illustrates the scan electrode driver 400 according to an exemplary embodiment of the present invention.

In FIG. 4, even though all of the switches are illustrated as n-channel field effect transistors (FETs) including body diodes (not shown), it is only illustrative, and the transistors may be substituted by other elements that are capable of performing the same or similar function as the n-channel field effect transistor in an exemplary embodiment of this invention. Further, in FIG. 4, a capacitive element formed by the X electrode and Y electrode is represented as a panel capacitor Cp.

As shown in FIG. 4, the scan electrode driver 400 includes a sustain driver 410, a reset driver 420, and a scan driver 430.

The sustain driver 410 includes an energy recovery unit 411, and transistors Ys, Yg. The sustain driver 410 alternately applies a Vs voltage and a GND voltage to the Y electrode during the sustain period.

The energy recovery unit 411 of the sustain driver 410 includes an energy recovery capacitor, an energy recovery inductor, a transistor that forms a rising path, and a transistor that forms a falling path. The energy recovery capacitor is charged to a voltage between the Vs voltage and the 0V voltage (for example, “Vs/2 voltage”). In this case, when the transistor that forms the rising path or the falling path is turned on, an LC resonance current path is formed between the energy recovery capacitor, the energy recovery inductor, and the panel capacitor Cp to increase or to decrease the voltage of the panel capacitor Cp. Because the energy recovery unit 411 is not directly related to an exemplary embodiment of the present invention, the description of the energy recovery unit 411 will be omitted.

A drain of the transistor Ys is connected to the Vs power supply that supplies the Vs voltage, a source of the transistor Ys is connected to a source of the transistor Ynp, and the transistor Ys applies the Vs voltage to the Y electrode when being turned on during the sustain period. A source of the transistor Yg is connected to the GND power supply that supplies the 0 V-voltage, a drain of the transistor Yg is connected to a drain of the transistor Ynp, and the transistor Yg applies the 0 V-voltage to the Y electrode when being turned on during the sustain period.

The reset driver 420 includes transistors Yrr, Ynp, Yfr and a Zener diode ZD. The reset driver 420 applies the reset rising waveform and the reset falling waveform to the Y electrode during the reset period.

As shown in FIG. 4, in the reset driver 420, a drain of the transistor Yrr is connected to the Vset power supply that supplies the Vset voltage, and a source thereof is connected to a source of the transistor Ynp. When the transistor Yrr is periodically turned on and turned off during the rising period of the reset period, the source voltage of the transistor Ynp is gradually increased to the Vset voltage. In this case, as the period of the turn-on operation of the transistor Yrr becomes larger, the slope of the reset rising waveform that is applied to the Y electrode becomes steeper.

Further, even though not shown in FIG. 4, when the Vset voltage is set to the same level as the Vs voltage, a first terminal of the transistor Yrr may be connected to the Vs power supply. With this configuration, the Vset power supply may be omitted, and the elements for preventing the formation of unnecessary current path between the Vset power supply and the Vs power supply may be omitted. Therefore, it is possible to design a simple circuit for the scan electrode driver 400.

A source of the transistor Yfr is connected to the VscL power supply that supplies the VscL voltage, and a drain thereof is connected to an anode of the Zener diode ZD. Further, a cathode of the Zener diode ZD is connected to a source of the transistor Ynp. Even though not shown, the positions of the Zener diode ZD and the transistor Yfr may be exchanged with each other. That is, the anode of the Zener diode may be connected to the VscL power supply. The cathode of the Zener diode may be connected to the source of the transistor Yfr, and the drain of the transistor Yfr may be connected to the source of the transistor Ynp.

When the transistor Yrr is periodically turned on and turned off during the falling period of the reset period, the source voltage of the transistor Ynp is gradually decreased from the VscL voltage to a Vnf voltage that is a breakdown voltage of the Zener diode ZD. In this case, as the period of the turn-on operation of the transistor Yfr becomes larger, the slope of the reset falling waveform that is applied to the Y electrode becomes steeper.

As shown in FIG. 4, a drain of the transistor Ynp is connected to the energy recovery unit 411 and the drain of the transistor Yg, and a source of the transistor Ynp is connected to the contact point of the sources of the transistors Ys, Yrr and the cathode of the Zener diode ZD. Because the transistor Yg includes a body diode having a cathode connected to the drain of the transistor Yg and an anode connected to the source of the transistor Yg, the current may flow from the GND power supply to the VscL power supply while VscL voltage or Vnf voltage that is lower than the 0V voltage is applied to the Y electrode. In order to prevent the current from flowing to the GND power supply, when a voltage that is lower than the 0 V-voltage is applied to the Y electrode, the transistor Ynp is turned off.

If the transistor Ynp is connected as described above, the transistor Ynp is included only in a current path when the transistor Yg is turned on, or the energy recovery operation is performed, and is not included in a current path for an operation for another transistor Ys or Yrr. Accordingly, the current that passes through the transistor Ynp is decreased to prevent the high heat generation, which prevents the damage or breakage of the transistor Ynp.

The scan driver 430 includes a diode DscH, a capacitor CscH, a transistor YscL and a selective circuit 431. Such a scan driver 430 sequentially applies the VscL voltage to a plurality of Y electrodes Y1 to Yn and applies the VscH voltage to at least one of the Y electrodes that does not apply the scan voltage.

A source of the transistor YscL is connected to the VscL power supply, and a drain thereof is connected to a source of the transistor Ynp. When the transistor YscL is turned on during the address period, the transistor YscL maintains the source voltage of the transistor Ynp to the VscL voltage.

A first terminal of the capacitor CscH is connected to the source of the transistor Ynp, and a second terminal thereof is connected to the cathode of the diode DscH. Further, an anode of the diode DscH is connected to the VscH power supply that supplies the VscH voltage. The diode DscH having the above configuration can prevent the formation of the current path including the VscH power supply while the voltage that is lower than the VscH voltage is applied to the Y electrode. Further, the capacitor CscH is charged to a dVscH voltage corresponding to the voltage difference VscH−VscL between the VscH voltage and the VscL voltage by turning on the transistor YscL during the initial driving of the plasma display device.

Further, the selective circuit 431 includes transistors Sch, Scl. A drain of the transistor Sch is connected to a second terminal of a capacitor CscH and a source thereof is connected to the Y electrode. A source of the transistor Scl is connected to the drain of the transistor YscL and a drain thereof is connected to the Y electrode. Even though the selective circuit 431 is connected to one Y electrode In FIG. 4, corresponding selective circuits may be connected to the plurality of Y electrodes, and the selective circuit 431 may be configured by an IC type in which a plurality of selective circuits are connected to each other.

Next, an operation for generating the driving waveform shown in FIG. 3 in the scan electrode driver 300 shown in FIG. 4 will be described.

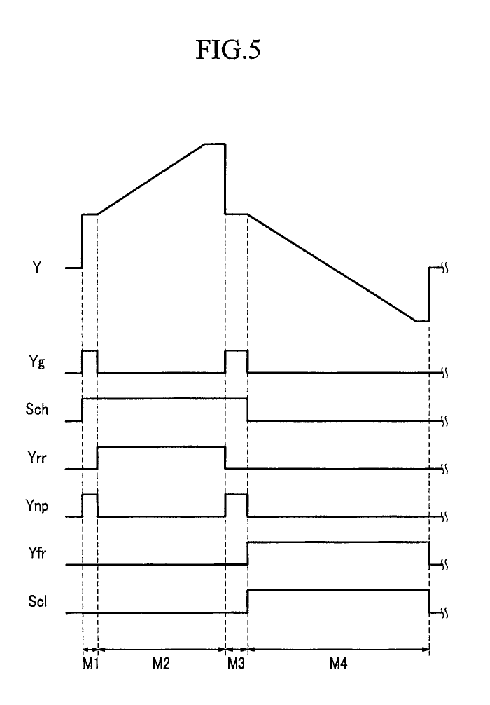

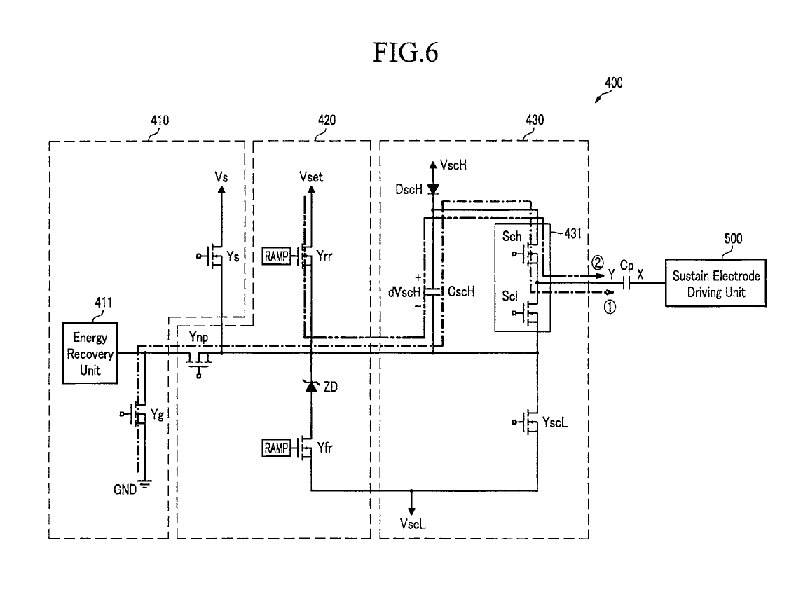

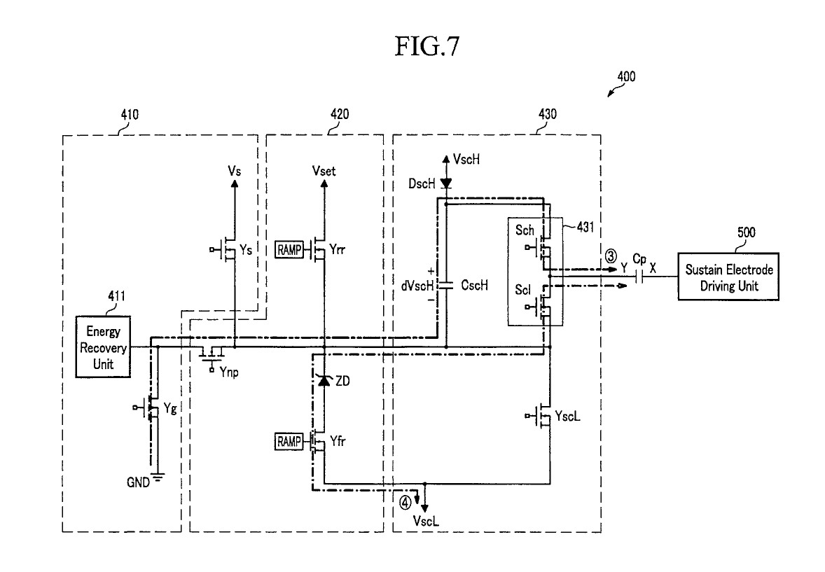

FIG. 5 illustrates a timing chart of transistors in the scan electrode driver 400 according to an exemplary embodiment of the present invention shown in FIG. 4 during a reset period. FIG. 6 illustrates a driving operation of the scan electrode driver 400 according to an exemplary embodiment of the present invention shown in FIG. 4 during a rising period of the reset period. FIG. 7 illustrates a driving operation of the scan electrode driver 400 according to an exemplary embodiment of the present invention shown in FIG. 4 during a falling period of the reset period.

First, it is assumed that the transistor YscL is turned on at the initial driving of the plasma display device, and the capacitor CscH is charged to the dVscH voltage corresponding to the difference VscH−VscL between the VscH voltage and the VscL voltage.

As shown in FIG. 5, the transistors Sch, Yg, Ynp are turned on in a first mode M1. By doing this, the dVscH voltage is applied to the Y electrode through a current path 1 of the GND power supply, the transistor Yg, the transistor Ynp, the capacitor CscH, the transistor Sch, and the panel capacitor Cp, as shown in FIG. 6.

Next, in a second mode M2, the transistor Yg and the transistor Ynp are turned off, and the transistor Yrr is turned on. By doing this, a current path 2 is formed by the Vset power supply, the transistor Yrr, the capacitor CscH, the transistor Sch and the panel capacitor Cp as shown in FIG. 6, and thus the voltage of the Y electrode is gradually increased to the dVscH+Vset voltage.

Next, in a third mode M3, the transistor Yrr is turned off, and the transistor Yg and the transistor Ynp are turned on. By doing so, the dVscH voltage is applied to the Y electrode through a current path 3 formed by the panel capacitor Cp, the transistor Sch, the capacitor CscH, the transistor Ynp, the transistor Yg and the GND power supply, as shown in FIG. 7.

Next, in a fourth mode M4, the transistor Sch, the transistor Yg, and the transistor Ynp are turned off, and the transistor Yfr and the transistor Scl are turned on. By doing so, the reset falling wave form is applied to the Y electrode through a current path 4 formed by the panel capacitor Cp, the transistor Scl, the Zener diode ZD, the transistor Yfr and the VscL power supply, as shown in FIG. 7,

The voltage of the Y electrode is gradually decreased from the GND voltage to the Vnf voltage through the current path 4. In this case, the Vnf voltage is higher than the negative VscL voltage by a breakdown voltage of the Zener diode ZD.

In order to prevent the strong discharge while reducing the time for the reset period, the dVscH voltage is applied to the Y electrode during the falling period of the reset period, when the voltage of the Y electrode is gradually decreased from the 0 V-voltage to the Vnf voltage after applying the 0 V-voltage, a fifth mode M5 may be included between the third mode M3 and the fourth mode M4. In the fifth mode M5, the transistor Yg, the transistor Ynp and the transistor Scl are turned on, to form a current path by the panel capacitor Cp and the transistor Scl, the transistor Ynp, the transistor Yg and the GND power supply. Further, the 0 V-voltage is applied to the Y electrode through the above current path.

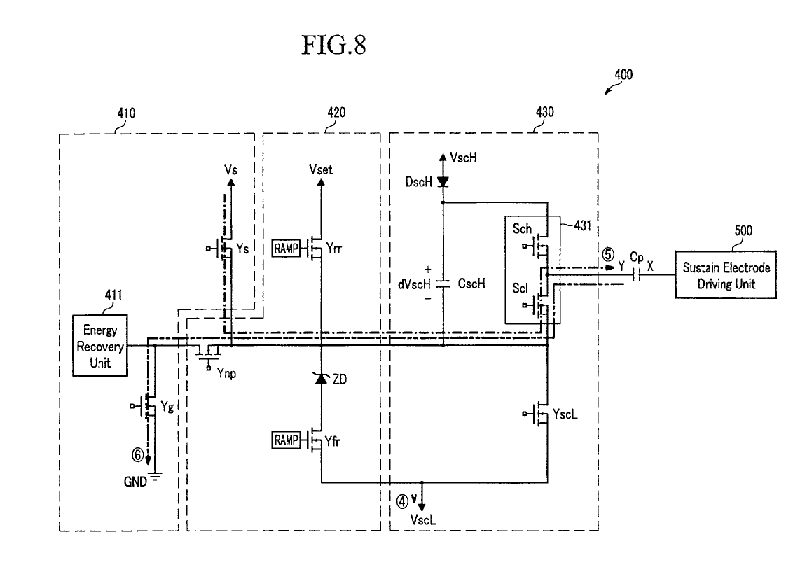

FIG. 8 illustrates a driving operation of the scan electrode driver 400 according to an exemplary embodiment of the present invention shown in FIG. 4 during a sustain period.

As shown in FIG. 8, if the transistor Ys and the transistor Scl are turned on, the voltage of the Y electrode is maintained to the Vs voltage through a current path 5 formed by the Vs power supply, the transistor Ys, the transistor Scl and the panel capacitor Cp.

Further, if the transistor Yg, the transistor Ynp and the transistor Scl are turned on, the voltage of the Y electrode is maintained to the 0 V-voltage through a current path 6 formed by the panel capacitor Cp, the transistor Scl, the transistor Ynp, the transistor Yg and the GND power supply.

As described above, according to an exemplary embodiment of the present invention, a first terminal of the transistor Ynp that prevents the formation of unnecessary current path in order to maintain the voltage of the Y electrode to a voltage lower than the reference voltage is connected to a contact point of the transistor Ys, the transistor Yrr and the Zener diode ZD, and a second terminal thereof is connected to the transistor Yg. Therefore, the transistor Ynp does not operate while the reset rising waveform, the reset falling waveform, and the Vs voltage are applied to the Y electrode, as a result, the heat generated from the element configuring the transistor Ynp can be reduced. Accordingly, the damage or breakage of the transistor Ynp can be prevented, which improves the reliability of the circuit. Furthermore, the current amount that passes through the transistor Ynp is reduced, and thus the transistor Ynp can be configured by elements having a reduced capacitance, as a result, the manufacturing cost for the plasma display device can be reduced. Furthermore, because the transistor Ynp is not included in the current path for applying the Vs voltage or reset rising waveform to the Y electrode, the distortion of the waveform that is applied to the Y electrode is prevented, as a result, the plasma display device can be stably driven during the sustain period and the address period.

According to an exemplary embodiment of the present invention, the plasma display device can be more stably driven with the improved reliability while preventing the distortion of the driving waveform.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A plasma display device, comprising:
a plasma display panel including a plurality of electrodes; and
a driver that applies a driving voltage to the plurality of electrodes,
wherein the driver includes:
a first transistor having a first transistor first terminal and a first transistor second terminal, the first transistor first terminal being connected to a first power supply that supplies a first voltage applied to the plurality of electrodes during a sustain period;
a second transistor having a second transistor first terminal and a second transistor second terminal, the second transistor first terminal being connected to a second power supply that supplies a second voltage applied to the plurality of electrodes during the sustain period, the second voltage being lower than the first voltage;
a third transistor having a third transistor first terminal and a third transistor second terminal, the third transistor first terminal being connected to a third power supply that supplies a third voltage, the third voltage being lower than the second voltage; and
a fourth transistor that has a fourth transistor first terminal and a fourth transistor second terminal, the fourth transistor first terminal being connected to the first transistor second terminal and the third transistor second terminal, the fourth transistor second terminal being connected to the second transistor second terminal, the fourth transistor being turned off while a voltage lower than the second voltage is applied to the plurality of electrodes.

2. The plasma display device of claim 1, wherein the driver further includes:
a fifth transistor having a fifth transistor first terminal and a fifth transistor second terminal, the fifth transistor first terminal being connected to a fourth power supply that supplies a fourth voltage, the fifth transistor second terminal being connected to the fourth transistor first terminal, the fifth transistor operating such that a voltage of the fourth transistor first terminal is gradually increased to the fourth voltage during a first period of the reset period.

3. The plasma display device of claim 2, wherein the fourth voltage is equal to the first voltage.

4. The plasma display device of claim 2, wherein when the fifth transistor is turned on, a current path is formed by the fourth power supply, the fifth transistor, and the plurality of electrodes.

5. The plasma display device of claim 2, the driver further includes a Zener diode having a cathode connected to the fourth transistor first terminal; and
a sixth transistor having a sixth transistor first terminal and a sixth transistor second terminal, the sixth transistor first terminal being connected to an anode of the Zener diode, the sixth transistor second terminal being connected to the third power supply, the sixth transistor operating such that a voltage of the fourth transistor first terminal is gradually decreased to a fifth voltage higher than the third voltage during a second period of the reset period.

6. The plasma display device of claim 5, wherein the fifth voltage is higher than the third voltage by a breakdown voltage of the Zener diode.

7. The plasma display device of claim 5, wherein when the sixth transistor is turned on, a current path is formed by the third power supply, the sixth transistor, the Zener diode and the plurality of electrodes.

8. The plasma display device of claim 1, wherein when the first transistor is turned on, a current path is formed by the first power supply, the first transistor, and the plurality of electrodes.

9. The plasma display device of claim 1, wherein when the second transistor and the fourth transistor are turned on, a current path is formed by the second power supply, the second transistor, the fourth transistor, and the plurality of electrodes.

10. The plasma display device of any one of claims 1, wherein the second transistor includes a body diode having a cathode connected to the second transistor second terminal and an anode connected to the second transistor first terminal, the second transistor second terminal being a drain of the second transistor and the second transistor first terminal being a source of the second transistor.

11. A driving apparatus for a plasma display device including a plurality of electrodes, the driving apparatus comprising:
a first transistor having a first transistor first terminal and a first transistor second terminal, the first transistor first terminal being connected to a first power supply that supplies a first voltage applied to the plurality of electrodes during a sustain period;
a second transistor having a second transistor first terminal and a second transistor second terminal, the second transistor first terminal being connected to a second power supply that supplies a second voltage, the second transistor operating such that a voltage of the second transistor second terminal is gradually increased to the second voltage during a reset period;
a third transistor having a third transistor first terminal and a third transistor second terminal, the third transistor first terminal being connected to a third power supply that supplies a third voltage applied to the plurality of electrodes during the sustain voltage, the third voltage being lower than the first voltage; and
a fourth transistor having a fourth transistor first terminal and a fourth transistor second terminal, the fourth transistor first terminal being connected to the first transistor second terminal and the second transistor second terminal, the fourth transistor second terminal being connected to the third transistor second terminal, the fourth transistor being turned off while a voltage lower than the third voltage is applied to the plurality of electrodes.

12. The driving apparatus of claim 11, wherein the fourth transistor is turned off while the first transistor or the second transistor are turned on.

13. The driving apparatus of claim 12, wherein when the third transistor and the fourth transistor are turned on, a current path is formed by the third power supply, the third transistor, the fourth transistor, and the plurality of electrodes to apply the third voltage to the plurality of electrodes.

14. The driving apparatus of claim 11, further comprising:
a fifth transistor having a fifth transistor first terminal and a fifth transistor second terminal, the fifth transistor first terminal being connected to a fourth power supply that supplies a fourth voltage, the fifth transistor second terminal being connected to the fourth transistor first terminal, the fourth voltage being lower than the third voltage;
a Zener diode having a cathode connected to the fourth transistor first terminal; and
a sixth transistor having a sixth transistor first terminal and a sixth transistor second terminal, the sixth transistor first terminal being connected to an anode of the Zener diode, the sixth transistor second terminal being connected to the fourth power supply, the sixth transistor operating such that a voltage of the fourth transistor first terminal is gradually decreased to a fifth voltage higher than the fourth voltage during a second period of the reset period.

15. The driving apparatus of claim 14, wherein the fifth voltage corresponds to a sum of the fourth voltage and the breakdown voltage of the Zener diode.

16. The driving apparatus of any one of claims 11, wherein the third transistor includes a body diode having a cathode connected to the third transistor second terminal and an anode connected to the third transistor first terminal, the third transistor first terminal being a source of the third transistor and the third transistor second terminal being a drain of the third transistor.

17. The driving apparatus of any one of claims 11, wherein the second voltage is equal to the first voltage.

18. A driving circuit for a plasma display panel including a plurality of electrodes, the driving circuit comprising:
a first transistor having a first transistor drain and a first transistor source, the first transistor drain being connected to a first power supply;
a second transistor having a second transistor drain and a second transistor source, the second transistor drain being connected to an energy recovery circuit, the second transistor source being connected to a second power supply;
a third transistor having a third transistor drain and a third transistor source, the third transistor source being connected to a third power supply;
a fourth transistor having a fourth transistor drain and a fourth transistor source, the fourth transistor drain being connected to the second transistor drain and the energy recovery circuit, the fourth transistor source being connected to the first transistor source and the third transistor drain;
a fifth transistor having a fifth transistor drain and a fifth transistor source, the fifth transistor drain being connected to a fourth power supply, and fifth transistor source being connected to the fourth transistor source and the third transistor drain;
a Zener diode having a Zener diode anode and a Zener diode cathode, the Zener diode cathode being connected to the fourth transistor source, the first transistor source, the fifth transistor source, and the third transistor drain;
a sixth transistor having a sixth transistor drain and a sixth transistor source, the sixth transistor drain being connected to the Zener diode anode, the sixth transistor source being connected to the third voltage;
wherein the fourth transistor source, the first transistor source, the fifth transistor source, the Zener diode cathode, and the third transistor drain are coupled to the plurality of electrodes.

19. The driving circuit as claimed in claim 18, further comprising:
a seventh transistor having a seventh transistor drain and a seventh transistor source, the seventh transistor source being connected to the plurality of electrodes;
an eighth transistor having an eighth transistor drain and an eighth transistor source, the eighth transistor drain being connected to the plurality of electrodes, the eighth transistor source being connected to the fourth transistor source, the first transistor source, the fifth transistor source, the Zener diode cathode, and the third transistor drain; and
a capacitor having a capacitor first terminal and a capacitor second terminal, the capacitor first terminal being connected to the seventh transistor drain and a fifth power supply, the capacitor second terminal being connected to the fourth transistor source, the first transistor source, the fifth transistor source, the Zener diode cathode, the third transistor drain, and the eighth transistor source.

20. The driving circuit as claimed in claim 19, wherein the first voltage is greater than or equal to the fourth voltage, the fourth voltage is greater than the second voltage, and the second voltage is greater than the third voltage, the third voltage being less than less than 0 V.
